(19) United States
(12) Patent Application Publication
(10) Pub. No.: US 2005/0174008 A1
(43) Pub. Date: Aug. 11, 2005

(54) DC MOTOR

(76) Inventor: Chin-Kun Tsai, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,138

(22) Filed: Feb. 4, 2005

(30) Foreign Application Priority Data
Feb. 5, 2004 (TW) 93102573

(51) Int. Cl. H02K 7/00; H02K 11/00; H02K 1/00

(52) U.S. Cl. 310/216; 310/254; 310/67 R

(57) ABSTRACT

A DC motor comprising a rotor and a stator is provided. Wherein, one of the rotor and the stator in which the polarity of each magnetic pole is fixed is defined as a fixing magnetic pole unit, and the other one in which the polarity of each magnetic pole is varied is defined as a switching magnetic pole unit. The fixing magnetic pole unit comprises a plurality of fixing magnetic poles, and the switching magnetic pole unit also comprises a plurality of switching magnetic poles. The total number of the magnetic poles in the switching magnetic pole unit is K times of the total number of the magnetic poles in the fixing magnetic pole unit, where K is a positive integer greater than 1. The dc motor of the present invention can eliminate the starting dead angel and maintain a high torque.

### CROSS-REFERENCE TO RELATED APPLICATION

This application claims the priority benefit of Taiwan application serial no. 93102573, filed on Feb. 5, 2004.

### BACKGROUND OF THE INVENTION

1. Field of the Invention

The present invention relates to a DC motor, and more particularly, to a DC motor in which the magnetic poles of the rotor is asymmetric with the magnetic poles of the stator.

2. Description of the Related Art

An electromotor is also known as a motor in the related field. The motor is roughly categorized as two types, including the DC motor and the AC motor, based on the electric power it utilizes. The DC motor is also categorized as stepping motor, servo motor, brushless motor (Hall motor), single-phase AC motor, 3-phase induction motor, series-wound DC motor, shunt-wound DC motor, and compound-wound DC motor.

Although the motors are categorized as different types, the basic operation principle of different motors is all same as follows. When a current is flowing through a stator, a magnetic field is generated, and when a rotor also has a magnetic field, the rotor of the motor is rotating due to a torque formed by the magnetic lines of force generating by cutting through the stator.

FIG. 1A through 1C are the diagrams illustrating the rotation of a conventional DC motor. Referring to FIG. 1A through 1C, wherein the DC motor 100 is one of the conventional DC motors comprising an outer rotor 103 and an inner stator 101. Specifically, the rotor 103 is configured as comprising a plurality of magnetic poles 21, 23, 25, and 27, which are made of a permanent magnet. The stator 101 is configured as comprising a plurality of magnetic poles 29, 31, 33, and 35 whose polarity is switchable and is made of a material such as silicon steel. As shown in FIG. 1A, the magnetic poles of the stator 101 in the DC motor 100 correspond to the magnetic poles of the rotor 103 in the DC motor 100, respectively. In other words, one magnetic pole of the stator 101 corresponds to one magnetic pole of the rotor 103.

In FIG. 1A, the DC motor 100 is in a starting state. Then, based on the principle of the magnetic force in which same polarity is exclusive and opposite polarity is affinitive. Same as the magnetic pole 21, all magnetic poles of the rotor 103 are attracted by the magnetic poles having opposite polarity on the stator 101, e.g. magnetic pole 29, and are also excluded by the magnetic poles having same polarity on the stator 101, e.g. magnetic pole 35. Accordingly, the rotor 103 starts to rotate in a clockwise direction by using the axis of the stator 101 as a spin axis as shown in FIG. 1B. When the rotor 103 rotates to a predetermined position as shown in FIG. 1C, the polarity of each magnetic pole on the stator 101 is switched. For example, the magnetic pole 35 is switched from a polarity of S pole to a polarity of N pole, such that the rotor 103 can continuously rotate with the help of the magnetic force.

In the DC motor 100, when the polarity of each magnetic pole on the stator 101 is switched, a low torque area where the exclusive and attraction forces of two poles are balanced is occurred. In the sections neighboring to this area, the torque of the rotor 103 is relatively smaller, thus it is required to push the rotor 103 away from this low torque area with an inertia force, so as to push the DC motor 100 to continuously rotate. If the DC motor 100 is just started, the inertia force of the rotor 103 may not be strong enough to push it away from the low torque area. In the conventional technique, a larger amount of current is required when the DC motor 100 is just started, thus a poor efficient method is used to deal with a maximum static friction force in order to push the rotor 103 away from the low torque area for completing its start operation.

A full-balance motor had been disclosed in ROC Patent No. 90102693 issued by Yan Chin-Fa and Yan Guo-Bin. However, in such design, the rotation of the rotor is controlled by using 7 magnetic poles for each unit of the stator, which not only greatly increases the complexity in designing the controlling circuit, but also significantly limits the applications it applies. In addition, a couple of zero poles have to be configured on the stator in this full-balance motor, which also makes waste in designing the magnetic poles.

### SUMMARY OF THE INVENTION

Therefore, it is an object of the present invention to provide a DC motor for eliminating a starting dead angle and maintaining a high torque.

It is another object of the present invention to provide a DC motor. The DC motor of the present invention is controlled by a brush or a brushless controlling circuit in order to provide better rotation efficiency and to save electric energy consumption.

In order to achieve the objects mentioned above and others, the present invention provides a DC motor, which comprises a rotor and a stator. Wherein, the rotor has an N magnetic pole and an S magnetic pole. Similarly, the stator also has an N magnetic pole and an S magnetic pole. Here, one of the rotor and the stator in which the polarity of each magnetic pole is fixed is defined as a fixing magnetic pole unit, and the other one in which the polarity of each magnetic pole is varied is defined as a switching magnetic pole unit. The fixing magnetic pole unit comprises a plurality of fixing magnetic poles, and the switching magnetic pole unit also comprises a plurality of switching magnetic poles. The total number of the magnetic poles in the switching magnetic pole unit is K times of the total number of the magnetic poles in the fixing magnetic pole unit, where K is a positive integer greater than 1.

According to another aspect of the present invention, the present invention provides a DC motor, which comprises a rotor, a stator, and a controlling circuit. Similarly, both the rotor and the stator have an N magnetic pole and an S magnetic pole. Here, one of the rotor and the stator in which the polarity of each magnetic pole is fixed is defined as a fixing magnetic pole unit, and the other one in which the polarity of each magnetic pole is varied is defined as a switching magnetic pole unit. The total number of the magnetic poles in the switching magnetic pole unit is K times of the total number of the magnetic poles in the fixing magnetic pole unit, where K is a positive integer greater than 1. In addition, the DC motor of the present invention is controlled by the controlling circuit to switch the polarity of each magnetic pole in the switching magnetic pole unit mentioned above and a switching timing, such that the rotor is always in an engaged state.

In summary, the present invention makes the ratio of the total number of the magnetic poles in the switching magnetic pole unit to the total number of the magnetic poles in the fixing magnetic pole unit equal to K times, such the starting dead angle is eliminated and the high torque value can be maintained.

In addition, the DC motor of the present invention can be implemented by a brush or a brushless controlling method, thus the present invention can be designed based on different user's requirement.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A through 1C are the diagrams illustrating the rotation of a conventional DC motor.

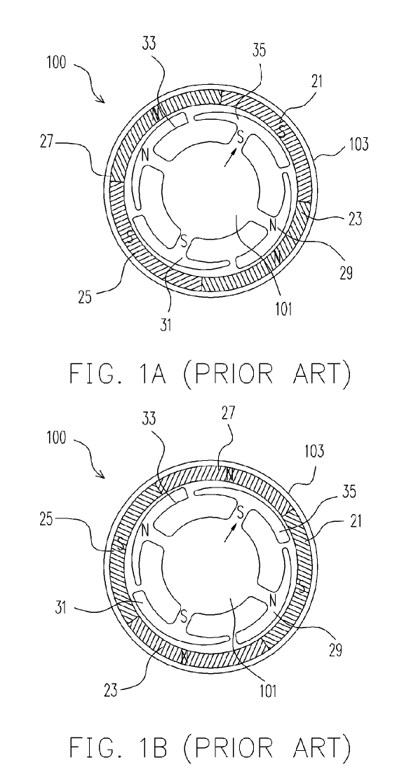

FIG. 2 schematically shows a structure diagram of a DC motor according to a first embodiment of the present invention.

FIG. 3A through 3C are the diagrams illustrating the rotation of a DC motor according to a second embodiment of the present invention.

FIG. 4 schematically shows a structure diagram of a DC motor according to a third embodiment of the present invention.

FIG. 5 schematically shows a structure diagram of a DC motor according to a fourth embodiment of the present invention.

FIG. 6A schematically shows a block diagram of a controlling circuit for controlling a brushless DC motor according to another embodiment of the present invention.

FIG. 6B schematically shows a block diagram of a controlling circuit for controlling a brush DC motor according to another embodiment of the present invention.

### DESCRIPTION OF THE PREFERRED EMBODIMENTS

The DC motor of the present invention is either an outer-rotor inner-stator DC motor or an inner-rotor outer-stator DC motor based on the relative position of the rotor and the stator. In addition, regarding to the type of the magnetic poles, in the outer-rotor inner-stator DC motor of the present invention, the polarity of the rotor is either a fixing magnetic pole polarity or a switching magnetic pole polarity. In the inner-rotor outer-stator DC motor of the present invention, the polarity of the rotor is either a fixing magnetic pole polarity or a switching magnetic pole polarity. In four cases mentioned above, the type of the magnetic poles in the stator is essentially opposite to the type of the magnetic poles in the rotor. In other words, when each magnetic pole in the rotor is the fixing magnetic pole polarity, each magnetic pole in the stator should be the switching magnetic pole polarity and vice versa. Here, one of the rotor and the stator in which the polarity of each magnetic pole is fixed is defined as a fixing magnetic pole unit, and the other one in which the polarity of each magnetic pole is varied is defined as a switching magnetic pole unit.

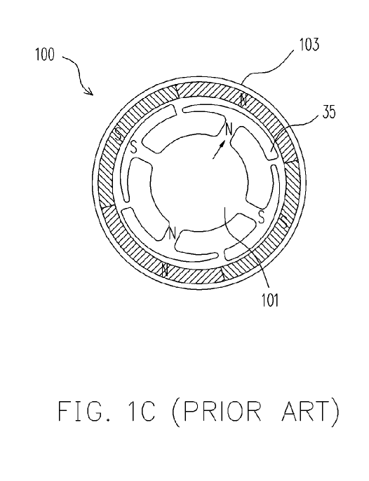

FIG. 2 schematically shows a structure diagram of a DC motor according to a first embodiment of the present invention. The concept of the present invention is described with referring to a DC motor 200 shown in FIG. 2 hereinafter. The DC motor 200 has an outer rotor 202 and an inner stator 204. Since each magnetic pole in the rotor 202 is made of a permanent magnet, the rotor 202 is a fixing magnetic pole unit. Conversely, the stator 204 is a switching magnetic pole unit, wherein each of its magnetic poles is made of an electro magnet whose polarity is switchable. In the present invention, the total number of the magnetic poles in the switching magnetic pole is designed as K times of the total number of the magnetic poles in the fixing magnetic pole, where K is a positive integer greater than 1. For example, in the DC motor 200, the rotor 202 has fixing magnetic poles 41 and 43, and the total number of the magnetic poles is 2. The stator 204 has switching magnetic poles 45, 47, 49, and 51, and the total number of the magnetic poles is 4, which is two times of the total number of the rotor 202, and K is equal to 2.

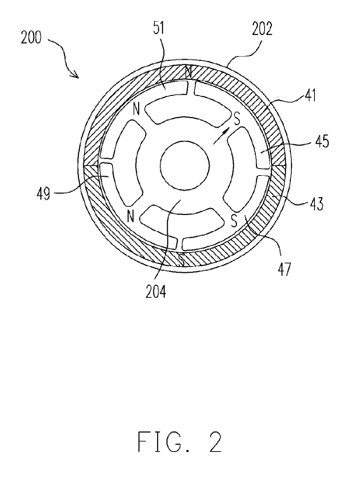

FIG. 3A through 3C are the diagrams illustrating the rotation of a DC motor according to a second embodiment of the present invention. Same as the previous embodiment, the DC motor 300 shown in FIG. 3A through 3C also has an outer rotor 302 and an inner stator 304. The rotor 302 is the fixing magnetic pole unit, and the stator 304 is the switching magnetic pole unit. In addition, the total number of the magnetic poles in the stator 304 is two times of the total number of the magnetic poles in the rotor 302 (8:4). In FIG. 3A, the DC motor 300 is in a starting state. Then, referring to FIG. 3B. Same as the fixing magnetic pole 53, all fixing magnetic poles of the rotor are pushed by the switching magnetic poles having same polarity, e.g. the switching magnetic pole 55, and also attracted by the switching magnetic poles having opposite polarity, e.g. magnetic poles 57 and 59. Accordingly, the rotor 302 starts to rotate in a clockwise direction. When the rotor 302 rotates to a predetermined position as shown in FIG. 3C, the polarity of some switching magnetic poles, e.g. the switching magnetic pole 57, is switched from the polarity of S pole to the polarity of N pole, or switched from the original polarity of N pole to the polarity of S pole like in the switching magnetic pole 61.

In the present invention, when the rotor is the fixing magnetic pole unit, that is when the stator is the switching magnetic pole unit, no matter the rotor is the inner rotor or the outer rotor, the switching magnetic pole having opposite polarity in the range corresponding to each fixing magnetic pole leads the switching magnetic pole having same polarity a predetermined angle in rotor's rotation direction. For example, the switching magnetic poles 57 and 55 are included in the range corresponding to the fixing magnetic pole 53 in FIG. 3A, and the rotor 302 is the fixing magnetic pole unit, thus the switching magnetic pole 57, whose polarity of the magnetic pole is same as the polarity in the fixing magnetic pole 57, leads the switching magnetic pole 55 having opposite polarity of magnetic pole a predetermined angle, wherein the predetermined angle in FIG. 3A is 45 degrees. In addition, it dose not matter how the rotor rotates, the total number of the switching magnetic poles included in the range corresponding to each fixing magnetic pole of the fixing magnetic pole unit is always equal to K. For example, although the range corresponding to the fixing magnetic pole 53 in FIG. 3B includes a full switching magnetic pole 57 and part of the switching magnetic poles 55 and 59, the total number of the switching magnetic poles is still equal to 2.

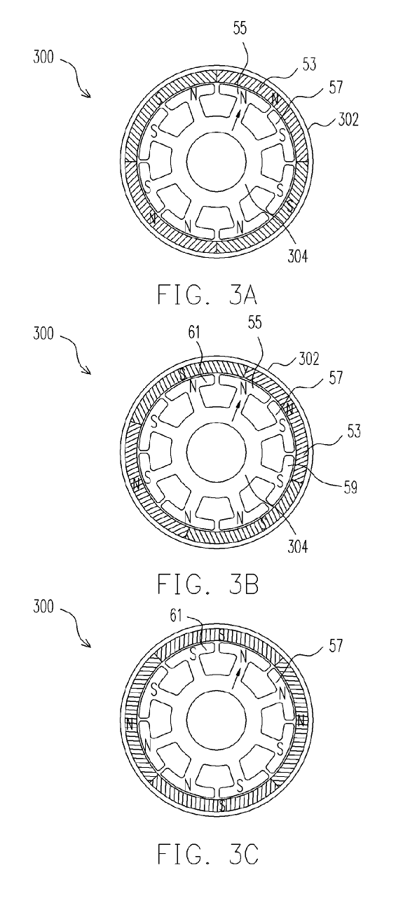

FIG. 4 schematically shows a structure diagram of a DC motor according to a third embodiment of the present invention. Referring to FIG. 4, in the present embodiment, the DC motor 400 has an outer rotor 404 and an inner stator 402. In addition, the stator 402 is an electro magnet, and the polarity of the magnetic pole is switchable based on the position of each magnetic pole of the rotor, thus the stator 402 is a switching magnetic pole unit. The rotor 404 is a permanent magnet, and the polarity of the magnetic pole is fixed, thus the rotor 404 is a fixing magnetic pole unit. In the present embodiment, the rotor 404 rotates in a clockwise direction, and its operation principle is the same as the one described in the previous embodiment, thus its detail is omitted herein.

Referring to FIG. 4, when the rotor is a fixing magnetic pole unit, no matter the rotor is an inner rotor or an outer rotor, the switching magnetic pole having opposite polarity in the range corresponding to each fixing magnetic pole in the fixing magnetic pole unit leads the switching magnetic pole having same polarity a predetermined angle in rotor's rotation direction. For example, the switching magnetic poles 65 and 67 are included in the range corresponding to the fixing magnetic pole 63, and the switching magnetic pole 67, whose polarity is different from the polarity of the fixing magnetic pole 63, leads the switching magnetic pole 65 having same polarity a predetermined angle. The predetermined angle in the present embodiment is 90 degrees. Similarly, it dose not matter how the rotor 404 rotates, the total number of the switching magnetic poles included in the range corresponding to each fixing magnetic pole of the fixing magnetic pole unit (rotor 404) is always equal to K.

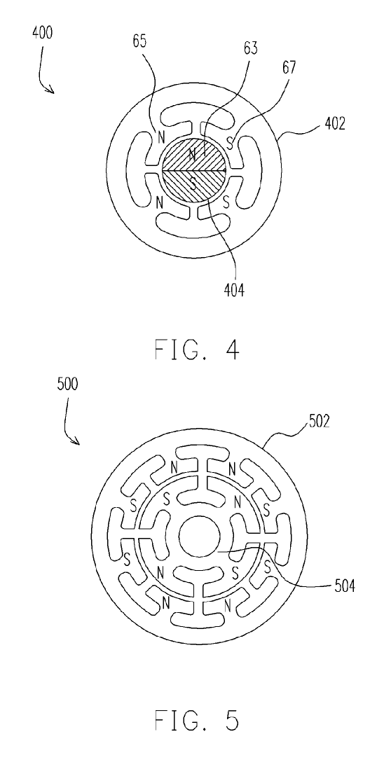

Although one of the rotor and the stator is a permanent magnet, and the other is an electro magnet as described in the embodiments mentioned above,, the present invention is not necessarily limited by it. Referring to FIG. 5, FIG. 5 schematically shows a structure diagram of a DC motor according to a fourth embodiment of the present invention. As shown in FIG.5, the DC motor 500 has an outer rotor 502 and an inner stator 504. However, both the rotor 504 and the stator 502 are the electro magnet.

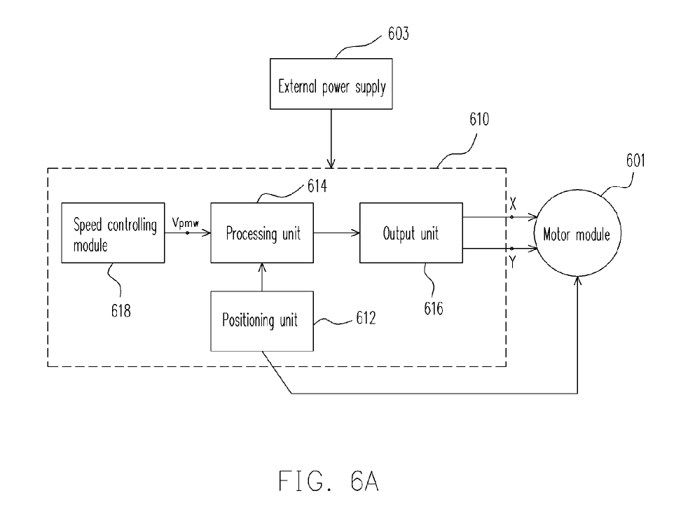

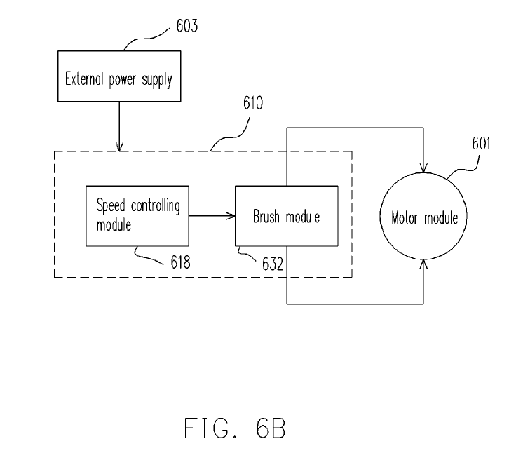

FIG. 6A schematically shows a block diagram of a controlling circuit for controlling a brushless DC motor according to a preferred embodiment of the present invention. Referring to FIG. 6A, the controlling circuit 610 receives an electric power from an external power supply 603, and changes the current direction via its output terminals X and Y to switch the polarity of each magnetic pole on the switching magnetic pole unit (not shown) inside the motor module 601, such that the rotor of the motor module 601 is engaged to rotate.

Referring to FIG. 6A, inside the controlling circuit 610, a positioning unit 61 2, for example a Hall IC or a Hall element, is electrically coupled to the motor module 601 for detecting a relative position between the rotor and the stator in the motor module 601, and a positioning signal Vₚ is generated to a processing unit 614. Then, a processing unit 614, for example a digital signal processor (DSP), generates a control signal V_{c} to the output unit 616 based on the positioning signal Vₚ in order to control the current flowing through the output terminals X and Y, so as to engage the rotor in the motor module 601 to rotate, and further to push the motor module 601 to rotate.

In another embodiment of the present invention, the controlling circuit 610 further comprises a speed controlling module 618, for example, a pulse width modulation (PWM) circuit. The speed controlling module 618 generates a PWM signal V_{pwm} to the processing unit 61 4 in order to modulate the speed of the rotor in the motor module 601. Wherein, the output of the speed controlling module 618 is directly coupled to the output terminal 616. Thus, the output terminal 616 can modulate the speed of the rotor in the motor module 601 based on the output of the speed controlling module 618.

FIG. 6B schematically shows a block diagram of a controlling circuit for controlling a brush DC motor according to another embodiment of the present invention. Referring to both FIG. 6A and 6B, in another embodiment of the present invention, the positioning unit 612, the processing unit 614, and the output unit 616 may be implemented with a brush module 632.

Although in both FIG. 6A and FIG. 6B, the controlling circuit 610 is configured outside of the motor module 601, the present invention is not necessarily limited by it. The controlling circuit 610 also can be configured inside the motor module 610 by the one of the ordinary skill in the art based on the physical requirement.

In summary, the present invention at least has following advantages.

1. Since the total number of the magnetic poles in the switching magnetic pole unit is K times of the total number of the magnetic poles in the fixing magnetic pole unit, a low torque area where the attraction and exclusion forces of two poles is balance is eliminated, such that the DC motor of the present invention can eliminate a starting dead angle and maintain a high torque when it is running.

2. The controlling circuit of the DC motor provided by the present invention can be implemented in either a brush or a brushless manner, and the rotor is designed to be interchangeable with the stator and vice versa, thus the DC motor of the present invention can satisfy the requirements of different environment in various applications.

3. In the DC motor of the present invention, it is easy to swap the polarity of each magnetic pole in the stator or in the rotor in order to achieve the objective of reverse spinning, such that the convenience is significantly improved. In addition, the diameter size and the layer thickness is also changeable by the one of the ordinary skill in the art according to the real space of various occasions and considering the cost of various applications in order to meet different physical requirements.

4. In the DC motor provided by the present invention, the fixing magnetic pole unit only requires one set of N and S fixing magnetic poles for its normal operation, and it is not required for the switching magnetic pole unit to use one magnetic pole as its dumb magnetic pole, thus the complexity in designing the controlling circuit of the DC motor is significantly reduced, and the cost is saved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A DC motor, comprising:
a rotor having an N magnetic pole and an S magnetic pole; and
a stator having an N magnetic pole and an S magnetic pole,
wherein, one of the rotor and the stator in which a polarity of each magnetic pole is fixed is defined as a fixing magnetic pole unit, which comprises a plurality of fixing magnetic poles, and the other one in which a polarity of each magnetic pole is varied is defined as a switching magnetic pole unit, which comprises a plurality of switching magnetic poles, and a total number of the magnetic poles in the switching magnetic pole unit is K times of a total number of the magnetic poles in the fixing magnetic pole unit, where K is a positive integer greater than 1.

2. The DC motor of claim 1, wherein the polarity of each magnetic pole in the switching magnetic pole unit is switched in order to push the rotor, and when the rotor is the fixing magnetic pole unit, the switching magnetic pole having opposite polarity in a range corresponding to each fixing magnetic pole in the fixing magnetic pole unit leads the switching magnetic pole having same polarity a predetermined angle in a rotor's rotation direction, and a total number of the switching magnetic poles included in the range corresponding to each magnetic pole in the fixing magnetic pole unit is equal to K.

3. The DC motor of claim 1, wherein the polarity of each magnetic pole in the switching magnetic pole unit is switched in order to push the rotor, and when the rotor is the switching magnetic pole unit, the switching magnetic pole having same polarity in a range corresponding to each fixing magnetic pole in the fixing magnetic pole unit leads the switching magnetic pole having opposite polarity a predetermined angle in a rotor's rotation direction, and a total number of the switching magnetic poles included in the range corresponding to each magnetic pole in the fixing magnetic pole unit is equal to K.

4. A DC motor, comprising:
a rotor having an N magnetic pole and an S magnetic pole;
a stator having an N magnetic pole and an S magnetic pole; and
a controlling circuit electrically coupled to an external power supply,
wherein, one of the rotor and the stator in which a polarity of each magnetic pole is fixed is defined as a fixing magnetic pole unit, and the other one in which a polarity of each magnetic pole is varied is defined as a switching magnetic pole unit, and a total number of the magnetic poles in the switching magnetic pole unit is K times of a total number of the magnetic poles in the fixing magnetic pole unit, where K is a positive integer greater than 1, in addition, the controlling circuit controls the DC motor to engage the rotor by switching the polarity of each magnetic pole in the switching magnetic pole unit and controlling a switching timing.

5. The DC motor of claim 4, wherein the controlling circuit comprises:
a positioning unit for detecting a relative position between part of the magnetic pole in the fixing magnetic pole unit and the corresponding magnetic pole in the switching magnetic pole unit;
a processing unit electrically coupled to the positioning unit; and
an output unit electrically coupled to the processing unit,
wherein, the processing unit controls the output unit to switch the polarity of each magnetic pole in the switching magnetic pole unit according to a signal indicating a relative position between each magnetic pole in the fixing magnetic pole unit and each corresponding magnetic pole in the switching magnetic pole unit detected by the positioning unit.

6. The DC motor of claim 5, wherein the positioning unit is either-Hall IC or Hall element, and the positioning unit sends a positioning signal to the processing unit according to a relative position between part of the magnetic pole in the fixing magnetic pole unit and the corresponding magnetic pole in the switching magnetic pole unit.

7. The DC motor of claim 6, wherein the processing unit comprises a digital signal processing circuit for generating a control signal based on the positioning signal.

8. The DC motor of claim 5, wherein the controlling circuit further comprises a speed controlling module for inputting a pulse width modulation (PWM) signal to the processing unit to modulate the speed of the rotor.

9. The DC motor of claim 5, wherein the positioning unit, the processing unit, and the output unit is implemented with a brush module, and the brush module is electrically coupled to the rotor for switching the polarity of each magnetic pole in the rotor to engage the rotor.

10. The DC motor of claim 9, wherein the controlling circuit further comprises a speed controlling module for receiving an electric power provided by a DC power supply to modulate the speed of the rotor.
